(19) United States
(12) Patent Application Publication
(10) Pub. No.: US 2025/0076247 A1
(43) Pub. Date: Mar. 6, 2025

(54) CREVICE CORROSION CELL

(71) Applicant: The Government of the United States of America, as represented by the Secretary of the Navy, Arlington, VA (US)

(72) Inventors: Carlos M. Hangarter, Alexandria, VA (US); Andrew B. Geltmacher, Arlington, VA (US); Nicole R. Tailleart, Alexandria, VA (US); William J. Kinee, Dunkirk, MD (US); Scott M. Olig, Huntington, MD (US); Patrick G. Callahan, Alexandria, VA (US); Dillon S. Watring, Washington, DC (US)

(73) Assignee: The Government of the United States of America, as represaented by the Secretary of the Navy, Arlington, VA (US)

(21) Appl. No.: 18/825,019

(22) Filed: Sep. 5, 2024

Related U.S. Application Data
(60) Provisional application No. 63/580,502, filed on Sep. 5, 2023.

(51) Int. Cl. G01N 27/419

(52) U.S. Cl. CPC G01N 27/419

(57) ABSTRACT

Disclosed herein is an apparatus for measuring crevice formation having a housing, a working electrode, a crevice former within the housing, a counter electrode within the housing, and a reference electrode within the housing. The electrodes and crevice former have electrical connections outside the housing. The crevice former has a silicon wafer having a thin film potentiometric sensor and is positioned within 100 μm of a surface of a sample in electrical connection with the working electrode. The housing is filled with electrolyte and both electrical testing and X-ray computed microtomography are performed on the sample.

### REFERENCE TO RELATED APPLICATIONS

This application claims the benefit of U.S. Provisional Application No. 63/580,502, filed on Sep. 5, 2023. The provisional application and all other publications and patent documents referred to throughout this nonprovisional application are incorporated herein by reference.

### TECHNICAL FIELD

The present disclosure is generally related to cells for measuring crevice corrosion.

### DESCRIPTION OF THE RELATED ART

Crevice corrosion is one of the major forms of corrosion characterized by intense localized corrosion due to blocked or occluded areas of metal exposed to electrolytes. This type of corrosion is often associated with micrometer scale (1-100 μm) gaps with stagnant electrolyte caused by holes, joints, threads, gaskets, surface deposits or fasteners, creating scenarios that are often concealed from visual inspection. Some specific forms of crevice corrosion include deposit corrosion, pillowing, filiform corrosion, or gasket corrosion.

Crevice corrosion often initiates from a differential oxygen cell, in which the occluded area experiences a depletion of oxygen. This is due to oxygen reduction occurring upon the entire surface at exchange current density or corrosion current levels that ultimately lead to transport limitations of oxygen into the crevice. The drop in oxygen concentration in the crevice region shifts the electrochemical potential of the occluded metal surface more negative than the boldly exposed area. The potential difference and metastable passivity within the crevice allows the boldly exposed area to drive corrosion within the crevice, much like a galvanic couple. Crevice corrosion can initiate with potential differences between boldly exposed and occluded surfaces as small as tens of millivolts.

Crevice corrosion propagation is accompanied by changes in electrolyte composition within the crevice. Specifically, crevice electrolytes exhibit marked increased in proton and chloride concentrations and decreased oxygen concentrations. This is primarily due to restricted exchange of ions and accumulation of metal cations within the crevice. The metal cations produced by corrosion undergo hydrolysis reactions that release protons for an overall drop in pH within the crevice. Proton accumulation drives chloride diffusion into the crevice for charge neutrality within the crevice electrolyte. The concentration of these species within the crevice can provide information of ongoing crevice corrosion damage, as models have been developed to determine chemical accumulation based on corrosion current and crevice geometry. Spatial and temporal information of these chemical species within the electrolyte could provide details of the evolving crevice corrosion localization and status.

Microstructural analysis of crevice corrosion coupons is often performed by line of sight optical profilometry. This process uses a stage to perform depth scans of the surface, optical interference and/or wavelength dependent confocal microscopy to assemble topographical constructs of surfaces. In some cases, resolution mismatch with sample size may also require stitching of images for a complete topographical construct. In all cases, line of site techniques are limited from accurately accessing undercutting and buried interfaces that occur in complex corrosion geometries such as pitting, exfoliation, crevice corrosion and those with in-tact coatings or corrosion product.

The lack of accessibility in actual practice is particularly concerning from an inspection and maintenance perspective as material degradation may proceed unmitigated to component failure (Sharland, A review of the theoretical modelling of crevice and pitting corrosion, Corros. Sci., 27 (1987) 289-323; Dawson et al., Crevice corrosion on 316 stainless steel in 3% sodium chloride solution, Corros. Sci., 26 (1986) 1027-1040). Likewise, the inherent requirement of a crevice former imposes challenges in characterizing this type of corrosion with in-situ techniques, outside of chronoamperometic techniques (Martin et al., Experimental procedure for crevice corrosion studies of Ni—Cr—Mo alloys in natural seawater, Rev. Sci. Instrum., 73 (2002) 1273-1276). This is due to spectral obstruction of the interface by the crevice former, which limits the view of the crevice and creates considerable difficulty in simply characterizing crevice dimension let alone tracking of corrosion under a crevice former.

Prior work by Lee and coworkers circumvented these limitations with lithographic patterning of microscale crevices (Lee et al., Factors Controlling the Location of Crevice Attack in Austenitic Stainless Steels, ECS Transactions, 41 (2012) 17). This approach provided well defined crevice channels down to 3 μm, which allowed for more rigorous analysis of iR contribution with simulations to capture observed crevice corrosion profiles. Alternative strategies have employed optically transparent crevice formers, such as glass, to visually monitor crevice formation with optical microscopy. This configuration also enables more complex studies with a colorimetric thin film on the interior face of the crevice former for detection of pH and chloride species within the crevice (Matsumura et al., Sudden pH and Cl⁻ Concentration Changes during the Crevice Corrosion of Type 430 Stainless Steel, J. Electrochem. Soc., 169 (2022) 101506; Nishimoto et al., Simultaneous visualization of pH and Cl⁻ distributions inside the crevice of stainless steel, Corros. Sci., 106 (2016) 298-302). This configuration enabled 2D visual and chemical monitoring of crevice initiation and growth. Importantly, these strategies all required post mortem analysis to evaluate mass loss and obtain 3D correlation with chronoamperometry and chemical species.

Alternatively, X-ray computed microtomography (XCMT) provides a non-destructive 3D localized view of material density on a microscale congruent with crevice corrosion. Previous work has demonstrated XCMT utility for observing pitting initiation and growth with incorporated electrochemical control of pitting and even applicability to stress corrosion cracking (Almuaili et al., Strain-induced reactivation of corrosion pits in austenitic stainless steel, Corros. Sci., 125 (2017) 12-19; Almuaili et al., Application of a Quasi In Situ Experimental Approach to Estimate 3-D Pitting Corrosion Kinetics in Stainless Steel, J. Electrochem. Soc., 163 (2016) C745; Eguchi et al., X-Ray tomographic characterisation of pitting corrosion in lean duplex stainless steel, Corros. Sci., 165 (2020) 108406; Ghahari et al., In situ synchrotron X-ray micro-tomography study of pitting corrosion in stainless steel, Corros. Sci., 53 (2011) 2684-2687; Ghahari et al., Synchrotron X-ray radiography studies of pitting corrosion of stainless steel: Extraction of pit propagation parameters, Corros. Sci., 100 (2015) 23-35; Marrow et al., Three dimensional observations and modelling of intergranular stress corrosion cracking in austenitic stainless steel, J. Nucl. Mater., 352 (2006) 62-74). These XCMT studies are typically for corrosion on ˜500 μm diameter wires, which is compatible with the scale of pitting morphology with varied interrogation frequencies that have reached quasi in-situ rates. These efforts have demonstrated the ability to observe pits, cracks and complex morphologies of lacy metal covers with microstructural details that provide insight into their degradation mechanism. Additionally, the 3D snapshot obtained with XCMT support quantitative evaluation of pit propagation parameters and metal diffusion coefficients (Ghahari et al., Corros. Sci., 100 (2015) 23-35). Efforts by Withers and coworkers have also utilized tomography with a suite of techniques for multiscale evaluation of pits (Burnett et al., Correlative Tomography, Scientific Reports, 4 (2014) 4711).

### SUMMARY OF THE INVENTION

Disclosed herein is an apparatus comprising: a housing, a working electrode within the housing and having a working electrode electrical connection outside the housing, a crevice former within the housing and having a crevice former electrical connection outside the housing, a counter electrode within the housing and having a counter electrode electrical connection outside the housing, and a reference electrode within the housing and having a reference electrode electrical connection outside the housing. The housing has a region for positioning a sample. The sample of interest, also known as the working electrode in electrochemical systems, is positioned such that it has a surface contacting the electrolyte and has an electrical contact outside the cell. The crevice former comprises a silicon wafer having a thin film potentiometric sensor on a surface of the wafer. The crevice former is positioned such that the potentiometric sensor is within 100 μm of a surface of the sample.

### BRIEF DESCRIPTION OF DRAWINGS

A more complete appreciation will be readily obtained by reference to the following Description of the Example Embodiments and the accompanying drawings.

FIG. 1 shows a schematic of a crevice corrosion cell integration with XCMT primary component.

FIG. 2 shows an enlarged view of a crevice corrosion cell component.

FIG. 3 shows open circuit potential measurement of AM316.

FIG. 4 shows corresponding chronoamperograms for potential holds from 0.1 to 1.0 V.

FIGS. 5A-E show XCMT scans of AM316 after OCP measurement (FIG. 5A), 0.7V for 1 hour (FIG. 5B), 0.8V for 1 hour (FIG. 5C), 0.9V for 1 hour (FIG. 5D) and 1.0V for 1 hour (FIG. 5E). All scans were performed at 5.9 mm voxel size with 1 hour scan time on a Zeiss Xradia 520 Versa X-Ray microscope. The images show the top corroding surface of the specimen.

FIGS. 6A-D show chronoamperometric log plots of current density to display power law type passivation behavior and deviation into crevice corrosion. Individual plots provide smaller range for greater distinction of plot features in order of 0.1 V (FIG. 6A), 0.2-0.3 V (FIG. 6B), 0.4-0.6 V (FIG. 6C) and 0.7-1.0 V (FIG. 6D).

FIGS. 7A-B show plots of the corrosion charge (FIG. 7A) and corresponding volume loss determined and depth equivalent (FIG. 7B) determined from chronoamperagrams at each potential.

FIG. 8 shows Pt crevice sensor potential during the indicated applied potential.

FIG. 9A shows a schematic of the crevice corrosion cell the AM316 working electrode, platinum wire counter electrode, Ag/AgCl reference electrode, and silicon crevice former with platinum thin film potentiometric sensors.

FIG. 9B shows an enlarged schematic of the crevice former and sample with range of sample sizes and crevice dimension.

FIG. 10 shows a schematic of sample, crevice former, crevice assembly and completed crevice corrosion cell and final configuration within the XCMT.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is a cell for chemical, electrochemical and X-ray tomography characterization of crevice corrosion. Details of the cell design, including Si crevice former with Pt thin film potentiometric pH sensor, are provided. The crevice former utilized a wrap around thin film contact to enable crevice side sensor operability with an unobstructed crevice configuration. The cell was evaluated with a series of potentiostatic holds that produced increased severity of crevice corrosion. XCMT observed nucleation and propagation of crevice corrosion. Furthermore, volume loss calculations displayed good correlation with potential dependent chronoamperometry, while capturing morphological progression of the crevice corrosion front. The sensor captured crevice acidification during potential holds and transport behavior effects during interim open circuit potential experiments. The results provide a multimodal view of crevice corrosion.

Crevice corrosion is distinct from pitting in that it includes lateral growth and a crevice former requirement. This translates to larger surface to induce and observe crevice corrosion, on the order of mm, and an X-ray source collinear with the sample surface. The disclosed XCMT crevice corrosion cell addresses these requirements with an embedded sample geometry and silicon crevice former. The crevice former is fabricated with a Pt thin film sensor that utilizes a wrap-around contact for continuous pH monitoring during crevice experiments. The cell design provides real time observation of crevice pH during electrochemically induced crevice corrosion experiments. Good correlation between coulometry and tomography measurement are demonstrated with volume loss calculations. This multimodal characterization approach presents significant advancements over standard crevice corrosion tests and facilitates a localized view of corrosion.

XCMT is a technique that uses X-ray radiation and the absorption properties of materials to produce electron density maps of a specimen in 3D. Thus, it is useful for identifying the surface features during the crevice corrosion experiment without having line of sight, due to the crevice-forming layer. Additionally, it can be used to locate the distribution, shape and volume fraction of second phases and porosity within the material specimens, when the density differences between the phases produce sufficient contrast. This information, combined with prior microstructural analyses of the exposed surface is important to determine the microstructural features controlling corrosion nucleation and growth. An XCMT system takes multiple radiographs of a specimen that is being rotated about a specimen axis. These radiographs are then combined into 3D tomographic images using various image reconstruction algorithms.

The cell described herein, including the various aspect and/or embodiments thereof, provides a cell design amenable to in situ microstructural analysis by XCMT during crevice corrosion. The apparatus may be used to understand crevice corrosion susceptibility of structural alloys, including mechanistic behavior and evolving corrosion morphology. This apparatus can provide additional information beyond standardized crevice corrosion cells with temporal and microstructural information of crevice corrosion origin and propagation.

The information produced by the apparatus sensors and XCMT is particularly useful when coupled with micro-analysis, such as energy dispersive spectroscopy (EDS) and electron backscatter diffraction (EBSD), and electrochemical monitoring, either open circuit potential, chronoamperometry, chronopotentiometry, polarization or electrochemical impedance spectroscopy (EIS). The combined approach enables electrochemical signatures to be correlated to microstructural phase and orientation at the initiation site of crevice corrosion and the propagation front. This apparatus is useful for examining alloys produced by non-traditional means that exhibit complex microstructures with thermodynamically unfavorable phases. This includes additive manufacturing, also known as rapid prototyping, 3D printing, or other advanced manufacturing techniques, such as friction stir welding, characterized by small melt pools and localized, anisotropic heating and cooling profiles not observed in wrought or cast processes.

The crevice corrosion cells are modified to allow spectroscopic evaluation of metal or metal alloys undergoing crevice corrosion. Spectroscopic evaluation data refers to XCMT to determine changes in sample volume or microstructure from electron density changes; however, it may also include spectroscopies such as ultraviolet-visible absorption (UV-vis), Fourier transform infrared spectroscopy (FTIR), Raman spectroscopy or nuclear magnetic resonance (NMR) spectroscopy. The apparatus is further modified with electrochemical, potentiometric sensors on the interior face of the crevice former to enable chemical monitoring of electrolytic species developing within the crevice due to corrosion reactions. The sensors may be produced by microfabrication or other thin film techniques to spatially determine chloride, oxygen, metal ion and pH concentrations within the crevice.

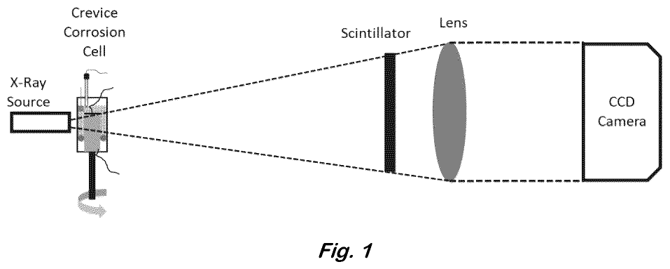

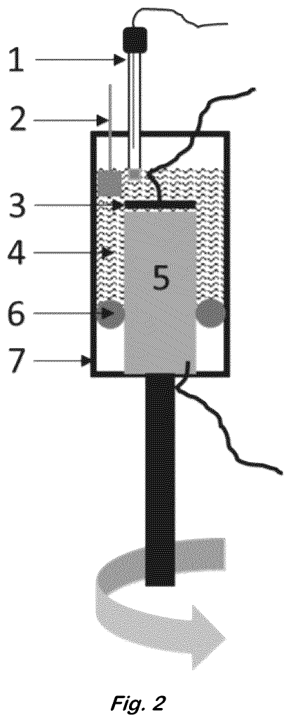

The cell can be used with both commercial XCMT systems and those available at synchrotron beamlines, where the latter often includes custom configurations. The former include an X-ray source, scintillator, lens, and CCD camera, where the sample is placed between the X-ray source and scintillator. In the current invention, the crevice corrosion cell is placed near the X-ray source, as shown in FIG. 1, to increase voxel resolution and is rotated for three dimensional tomography. The sample size may range from microns to mm or even cm depending upon the X-ray tomography system. The distance between the X-ray source and detector components can be adjusted depending on sample of interest and resolution desired. Similarly, the sample position can be adjusted and additional optics between the sample and X-ray source are often available to further refine resolution in most commercial XCMT systems. Furthermore, the cell, shown in greater detail in FIG. 2, is comprised of the basic components of a reference electrode 1, counter electrode 2, crevice former 3, electrolyte 4, working electrode 5, seals 6, and cell body 7. This configuration enables electrochemical techniques with full potential control of a three-electrode configuration, such as polarization, chronoamperometry, and EIS, by which to evaluate the material of interest under crevice conditions. The crevice former 4 can be positioned in direct contact with samples 5, especially in the case of those exhibiting a rough surface or samples that have boldly exposed sidewalls. Crevice formers may also incorporate the use of plastics and or rubber to create the crevice. Examples in this approach include the use of tape and photoresists on the underside of the crevice former, where the tape creates a seal on three sides of the crevice former to allow oxygen transport from only one direction into the crevice. The electrolyte is generally comprised of water and salt containing aggressive halides but may also include other salts, acids, alkaline media and other solvents. Additionally, the working sample may be fully comprised of the material of interest or consist of a sample embedded in epoxy, or other low electron density material, to control the surfaces exposed to electrolyte. This configuration contains inert o-rings 6, such as viton, to seal the cell and prevent loss of the electrolyte. Additionally the cell body is comprised of a low electron density material such as plastic, glass or quartz to minimize X-ray attenuation.

Additionally the crevice former may contain microfabricated electrodes to be used for chemical detection within the crevice. In the case of a crevice former with a sensor array, electric wires from the reference electrode 1, counter electrode 2, and crevice former 3 are routed along the XCMT ceiling or a suspended fixture to limit beam interactions. Similarly, the electric wire contacting the sample 5 is routed on the floor of the system to minimize X-ray interactions. Variations of this configuration may eliminate wires altogether by excluding features such as the reference electrode 1, counter electrode 2, and integrated sensor array in case of naturally occurring crevice formation without sensors. Additional variations include the use of springs or other mechanical components used to maintain a specified force upon the crevice former.

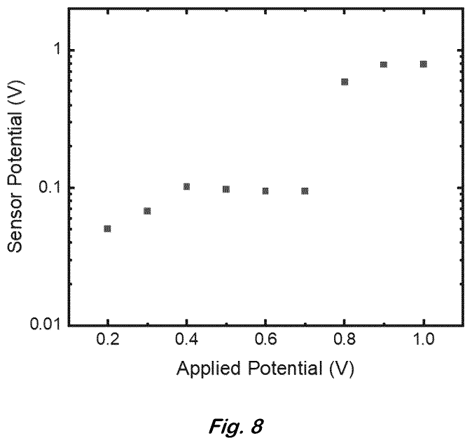

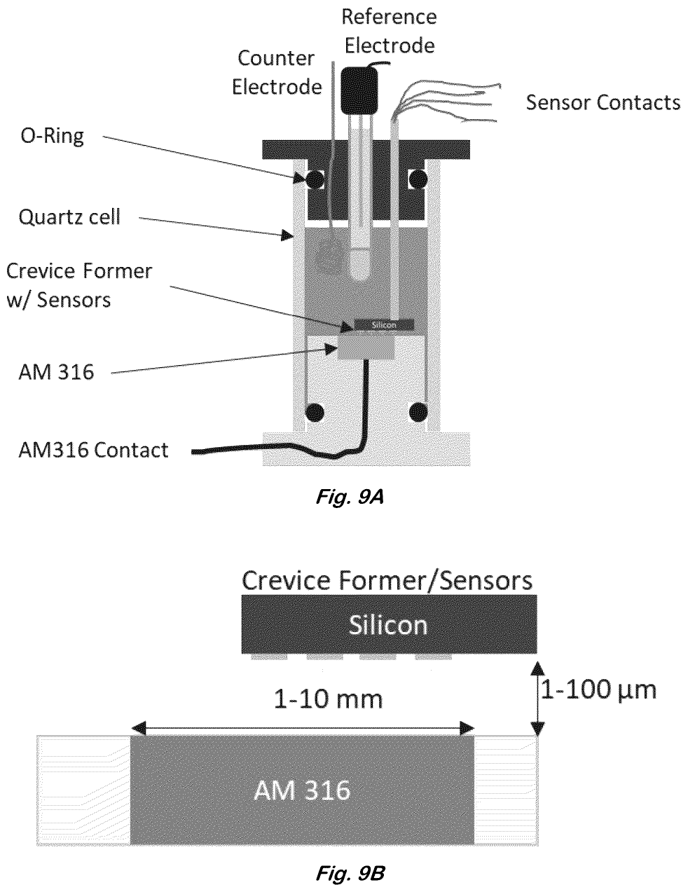

The detailed components of the crevice corrosion cell, including those of the crevice former, are shown in the schematics of FIGS. 9A-B. The fully assembled cell is operated in a three-electrode configuration with platinum wire counter electrode and Ag/AgCl reference electrode to provide accurate monitoring and control of the AM316 by means of a potentiostat. This configuration, shown in FIGS. 9A-B, enables a number of electrochemical tests to be performed such as open circuit potential (OCP), polarization, potentiostatic and electrochemical impedance spectroscopy, to ascertain corrosion properties of materials. The same reference electrode was used to determine the potential of the individual electrochemical platinum potentiometric sensor by means of an additional potentiostat and multiplexor.

The crevice cell sample is comprised of a columnar geometry similar to previous XCMT pitting configurations. Columnar geometries minimize the electron density cross section for improved voxel resolution with characteristic lengths dependent upon material. In this work, stainless steel sample diameters of 2 mm-5 mm were examined with resolution that spanned 10-100 μm³. The column is cast in epoxy and polished to a mirror finish to enable improved planarity and contact with the crevice former. This crevice assembly limits the amount of surface area that can be contained in the crevice or boldly exposed region, however, sample sidewall exposure can be used to augment the latter for larger ratios of boldly exposed to crevice area (Nishimoto et al., Corros. Sci., 106 (2016) 298-302). This strategy typically relies upon longer column lengths and embedding the lower portion to produce a structure with exposed side walls. The ratio of boldly exposed area to crevice area has been shown to be an important metric for crevice corrosion experiments, in which larger values have been shown to exacerbate or accelerate corrosion damage (Cui et al., Computational modeling of cathodic limitations on localized corrosion of wetted SS 316L at room temperature, Corros. Sci., 47 (2005) 2987-3005).

In addition to sidewall exposure, the epoxy can serve the additional function of electrolyte containment, along with other cell components, while facilitating electrical contact to the sample. The electrical contact for the sample design was a threaded contact to the bottom of the sample, which also served as a mechanical mount for the cell assembly. The cell body has an o-ring fitting to the sample with subsequent attachment of the cell cap and supporting electrodes to the cell body. Other variations include o-ring seals on the mount as opposed to o-ring seals on the sample.

The sample in this work was cut from a bulk print of additively manufactured UNS S31600. The laser powder bed fusion (LPBF) samples examined in this study were fabricated on an EOS M290 using virgin EOS Stainless Steel 316L powder and a 1045 mild steel build platform. The chemical composition as supplied by the manufacturer conforms to the composition standards described in ASTM F138. Two build plates of additively manufactured (AM) 316L stainless steel (316L SS) samples were fabricated for testing to evaluate the effects of post-processing on the mechanical properties and corrosion performance. Fabrication was done under a 99.999% Ar atmosphere at 195 W power, 1083 mm/s laser speed, 20 μm layer thickness, 90 μm hatch distance, 5 mm stripe width, and 120 μm stripe overlap. The resultant porosity was <0.1%. The as received AM316 contained off stoichiometry Ni and Nb enrichment of the standard composition for increased nobility and is hereafter referred to as AM316 (Table 1). Samples were machined to 10 mm tall column with a square cross section, 3.5 mm on a side, with sample axis in-line with the X-Y print directions. After the sample was embedded in epoxy, it was submitted to successively finer grinding paper and polishing slurries to a final 20 nm SiO₂ finish.

TABLE 1
Nominal chemical composition of AM 316L SS

| Element | Fe | Cr | Ni | Mo | C | Mn | Cu | P | S | Si | N |
|---|---|---|---|---|---|---|---|---|---|---|---|
| Min | Bal. | 19.6 | 31.8 | 2.2 | | 1.5 | | | | | |
| Max | Bal. | 19.00 | 15.00 | 3.00 | 0.030 | 2.00 | 0.50 | 0.025 | 0.010 | 0.75 | 0.10 |

Crevice former integration is tantamount to crevice corrosion cell performance, as the crevice gap, crevice former planarity as well as the chemical composition can impact crevice corrosion (Lee et al., ECS Transactions, 41 (2012) 17; Guo et al., Enhanced crevice corrosion of stainless steel 316 by degradation of Cr-containing hollandite crevice former, Corros. Sci., 205 (2022) 110462; Guo et al., Near-field corrosion interactions between glass and corrosion resistant alloys, npj Materials Degradation, 4 (2020) 10; Lee et al., Combining Rigorously Controlled Crevice Geometry and Computational Modeling for Study of Crevice Corrosion Scaling Factors, J. Electrochem. Soc., 151 (2004) B423). In the present design, the crevice former was comprised of a 500 μm thick silicon wafer diced to a square 0.5 cm on a side. Furthermore, the crevice former was outfitted with a Pt thin film potentiometric sensor on the interior of the crevice to facilitate pH measurements. Chemical changes within the crevice, particularly in terms of pH, chloride and oxygen concentration, are important indicators of corrosion reactions during crevice initiation and propagation. These reactions include the oxidation of metal species, particularly Fe and Cr, and their hydrolysis reactions:

$$Fe \to {Fe}^{2 +} + 2 {e}^{-} \qquad Reaction 1$$

$$Cr \to {Cr}^{3 +} + 3 {e}^{-} \qquad Reaction 2$$

$${M}^{n +} + {n H}_{2} O \to {M ( {OH}^{-} )}_{n} + {n H}^{+} \qquad Reaction 3$$

Reaction 3 can produce a significant drop in pH due to proton confinement within the crevice. For stainless steels the hydrolysis of Cr is much stronger than Fe, and is therefore the primary reaction leading to crevice acidification. This pH change has been a traditionally difficult measurement due to accessibility challenges with macroscopic sensors. Here these challenges are circumvented with a wrap around Pt thin film to enable open circuit potential measurements indicative of pH values. These measurements require an additional potentiostat that utilizes the same reference electrode as that used for crevice characterization. Sensor interpretation requires calibration that was performed in aqueous solutions of the target electrolyte 0.6 M NaCl at pH values of 2.0, 4.5, 7.0, 9.5, and 12.0. The calibration results indicated a responsivity of 0.036 V/pH. While falling short of ideal Nernstian 0.59 V/pH, alternative materials, such as IrO₂, and polymeric coatings can be incorporated for greater sensitivity and selectivity.

Crevice former—Electrical contact to the Pt sensor is an important aspect of sensor operability and crevice formation. Standard soldering or wire bonding techniques on the crevice side of the crevice former can impede crevice formation. Electrical contacts were therefore made by a wrap around lithographic defined thin film, using mylar tape as a mask. This enable wired bonding on the back side that would not interfere with the crevice. A Ti/Pt, 10/50 nm thin film was e-beam deposited with the crevice former at a 450 angle while rotating to ensure the three sides, front, back and edge, were coated with a continuous metal film. Electrical contact to the thin film was made with a 36 gauge stranded Cu wire and Ag paint and then potted in epoxy for electrical isolation. The wire assembly is contained in a rigid plastic tube on the back side of the crevice former used to apply mechanical pressure. Although this particular design did not integrate a pressure-stabilizing component such as a spring or wave ring, such features can be easily incorporated into the present design. The crevice former gap was set to 70 μm with mylar tape with a silicone adhesive fixed to the internal face of the crevice former. In this context, an additional advantage of Si wafer crevice former is facile implementation of lithographically patterned crevices, in which the crevice gap is defined by photoresist height.

Crevice cell—The fully assembled cell is operated in a three-electrode configuration with platinum wire counter electrode and Ag/AgCl reference electrode to provide accurate electrochemical monitoring and control by means of potentiostat. All potentials reported herein are in volts vs. Ag/AgCl (V). The electrolyte was ˜3 ml of 0.6 M NaCl exposed to ambient laboratory conditions and oxygenation. A quartz tube with a 10 mm inner diameter was used as the cell body to minimize beam attenuation. The cell was sealed on the sample and cap end by O-rings.

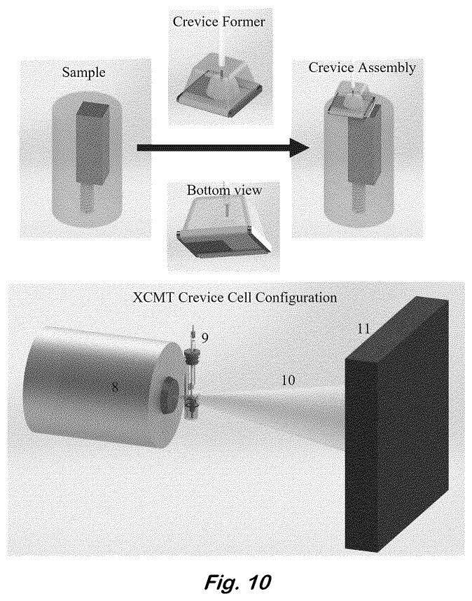

XCMT crevice cell configuration—All tomography measurements were performed on a Zeiss Xradia 520 Versa X-Ray computed micro-tomography (XCMT) system. This configuration of the crevice corrosion cell is shown schematically in FIG. 10. During operation, the cell is positioned in close proximity to the X-ray source for greater resolution. The electrical contact for the working electrode was routed along the XCMT chamber floor while the counter electrode, reference electrode and sensor wiring was routed along the chamber ceiling. This particular XCMT system utilizes a rotating (±180°) sample to capture a full set of cross-section projections.

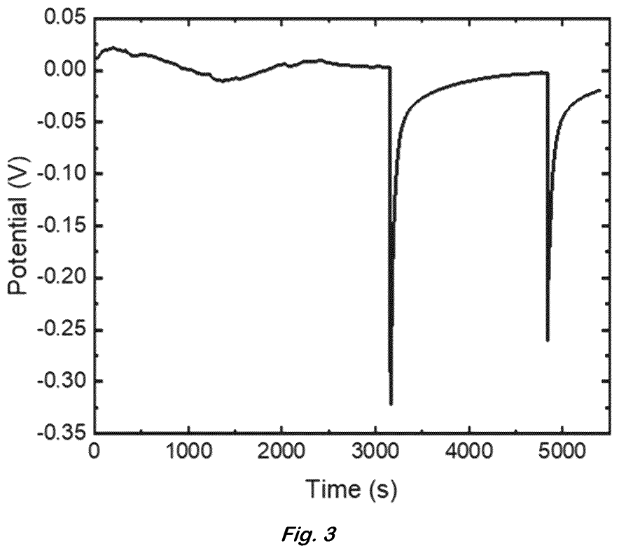

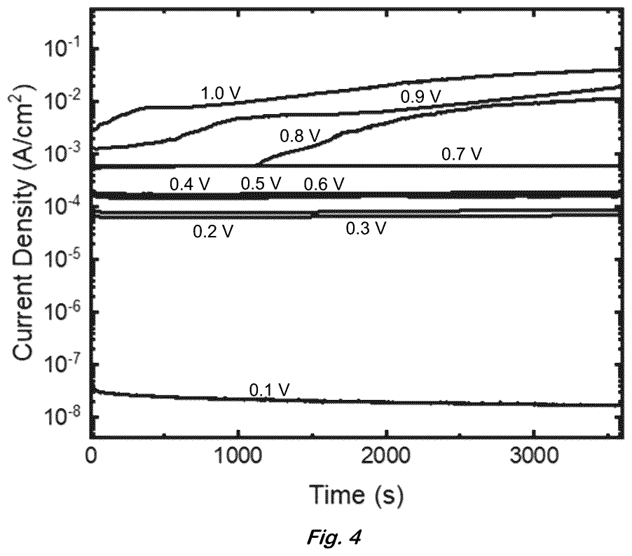

The OCP of the sample is shown in FIGS. 3-4. This measurement was conducted during an XCMT scan to illustrate in-situ measurement capability. This plot shows the corrosion potential is near 0.0 V vs. Ag/AgCl with the peaks in potential indicative of passive film metastability. That is, the rapid decrease in open circuit, ˜0.3 V, is indicative of depassivation. This may be confined to features associated with surface finish or microstructure, such as an intermetallic or more active phase. The rapid recovery to near pre-event OCP values is an indication the depassivation event has stabilized or repassivated. Any relationship between metastability and X-ray source is undetermined for these experiments.

The potentiostatic experiments in this work highlighted the use of electrochemical chonoamperograms, shown in FIG. 4, with XCMT for assessment of crevice corrosion. The imposed anodic potential relative to OCP accelerates crevice corrosion by promoting oxidation reactions that destabilize the passive film and subsequent acidification within the crevice. In these experiments, the potentiostatic hold was performed at 0.1 V, then an XCMT scan was performed. The process was repeated in a stepwise fashion with the applied potential increasing in 0.1 V steps with each step. The chronoampergrams for each potential from 0.1 to 1.0 V are plotted on a semi-log plot to facilitate analysis of crevice corrosion onset. The low current at 0.1 V is characteristic of passive film dynamics without crevice corrosion. In this particular set of data, crevice corrosion onset can be interpreted as 0.8 V from chronoamperometry, which displays a clear exponential jump in current due to passive film compromise and rapid corrosion.

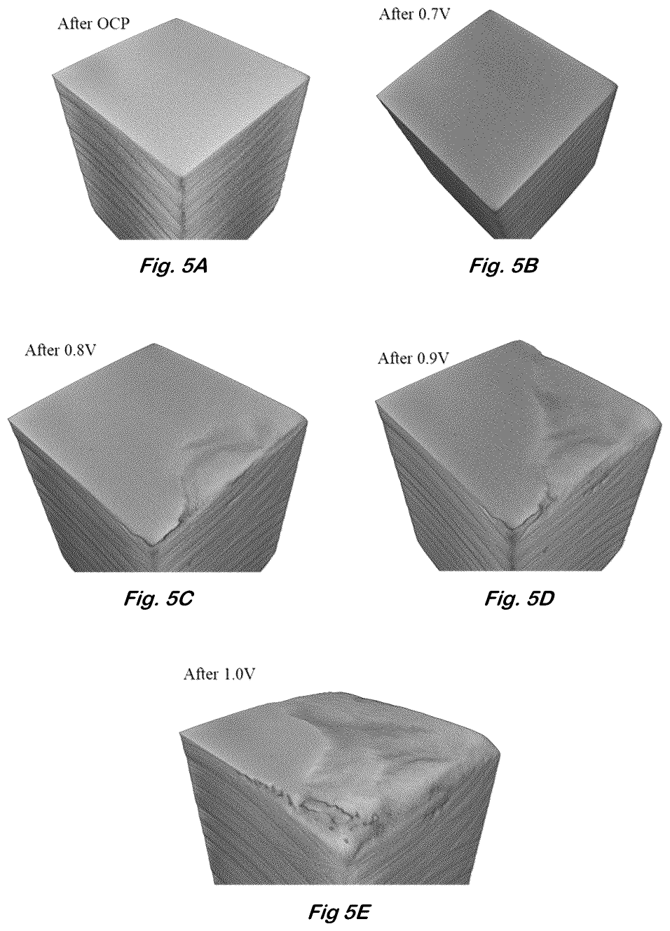

XCMT scans of the sample were performed before and after the OCP measurement, and after each step in the potentiostatic experiment. Example XCMT scans of the corroding specimen are shown in FIGS. 5A-E emphasizing the top surface of the specimen. The selected images are for the specimen after OCP measurement and after potential holds of 0.7 V, 0.8 V, 0.9 V and 1.0 V. The XCMT reconstruction after OCP to 0.7 V (i.e., OCP, 0.1, 0.2, 0.3, 0.4 0.5 0.6 and 0.7 V) are nominally the same, with no observable change in the surface of the specimen. However, volume loss and corrosion damage during the 0.8 V hold is apparent in FIG. 5C, consistent with electrochemical chronoampergrams. Furthermore, as the potentiostatic experiments reach higher values the evolution of the corrosion damage is observed in the XCMT reconstructions. These volume reconstructions have been used to determine volume loss during each step of the potentiostatic experiment. These XCMT measurements show a mass loss of 0.12 mm³, 0.14 mm³ and 0.32 mm³ after the 0.8 V, 0.9 V and 1.0 V potential holds, respectively.

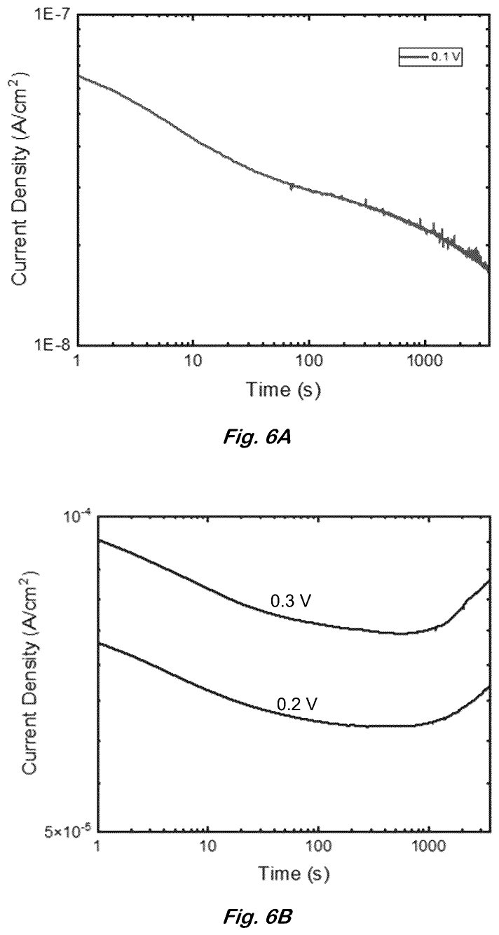

Potentiostatic chronoamperometry can be quantitatively compared to XCMT volume loss measurements by chronoamperometric analysis. These experiments display a current density decay as the passive film stabilizes, followed by an exponential increase in current density, with the intersection between the two regions defined as crevice corrosion initiation. Thus a power law relationship was applied to chronoamperograms in FIGS. 6A-D to assess crevice initiation times, in accord with techniques established by Martin and coworkers (Martin et al., Rev. Sci. Instrum., 73 (2002) 1273-1276). This approach determines crevice initiation from extrapolation of the corrosion current fit to the observed current minimum. From FIGS. 6A-D it is seen that 0.1 V is the only potential that did not display some indication of passivation deviation. The chronoamperograms for 0.2 V to 0.7 V all reach a positive slope within the 1 hour experiment, but the current magnitudes are still within the range observed for passive film growth. A sharp exponential increase in current, beyond the passivation current level, is not displayed until 1100 sec at 0.8 V. The subsequent potential holds at 0.9 V and 1.0 V exhibit a shorter transition from passivation decay to crevice corrosion onset.

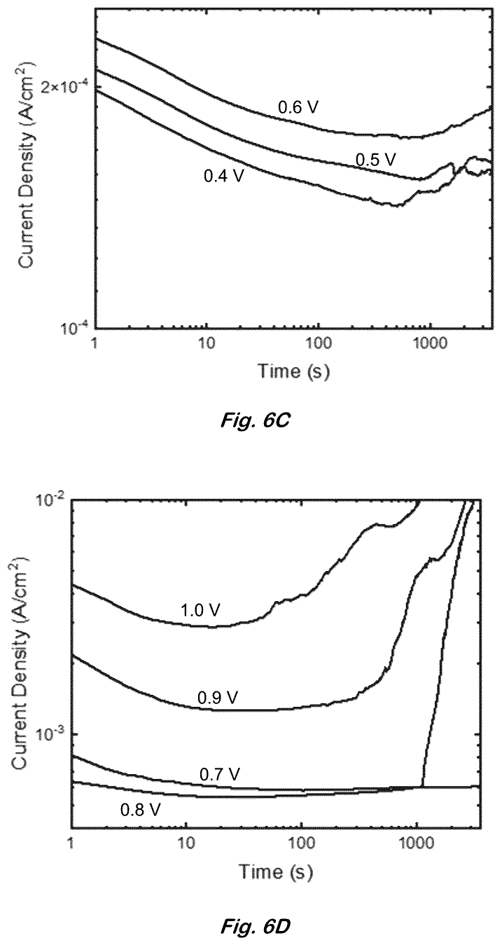

Quantification of corrosion charge was used to calculate material volume loss. The ASTM standard G102 provides guidelines for generating corrosion rate from electrochemical current, Faraday's constant, material density and equivalent weight. Utilizing a similar approach, the corrosion current from chronoamperograms can be used to estimate volume loss.

$$V = \frac{{QW}_{e}}{nF ρ} \qquad Equation 1$$

Where V is the volume, Q is the charge integrated from the chronoamperogram, We is the equivalent weight, n is reaction valence, F is Faraday's constant and ρ is density. The corrosion current for these purposes is defined as the current measured after crevice initiation time, with charge being integrated from that point forward with background subtraction taken from the current minimum. Utilizing this approach, the corrosion charge is shown to jump by nearly three orders of magnitude above 0.7 V (FIGS. 7A-B). This difference can be understood in terms of a volume loss or depth equivalent, which assumes uniform corrosion damage across the sample. In FIG. 6B the volume loss and depth equivalent can be shown to increase at 0.8 V, with a cumulative depth equivalent of 34.4 μm over the course these experiments. The corresponding cumulative volume loss, FIG. 6C, reaches 0.31 mm³. Thus, there is excellent agreement between the chronoamperometric calculation (0.31 mm³) and XCMT measurement (0.32 mm³) of the corrosion volume loss over the described experiment.

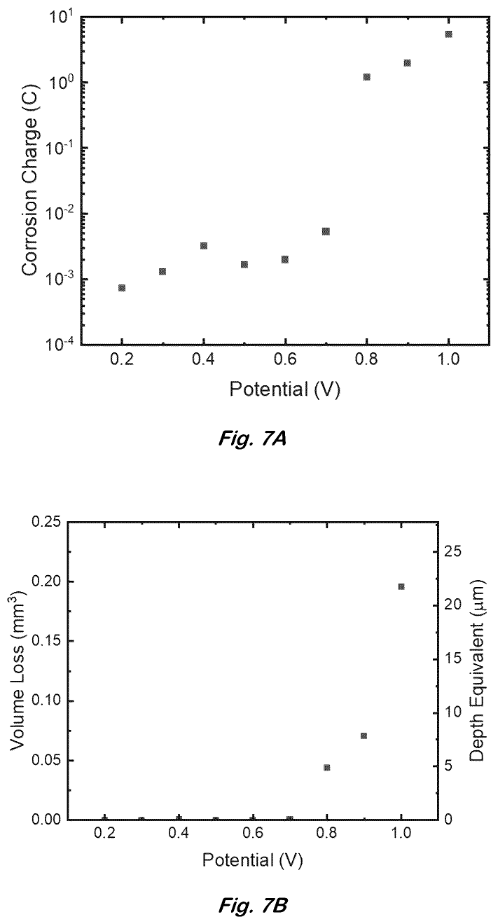

A potentiometic Pt thin film was used to monitor pH within the crevice during AM316 chronoamperometric crevice experiments. The sensor response to applied potentials (FIG. 8A) is shown to increase at lower potentials and stabilize between 0.4 and 0.7 V. At greater applied potentials the sensor potential increases by ˜0.5 V. This large potential change represents a significant change on the pH scale based on the calibration curve. However, the calibration curve for these sensors spans between pH 2 and 12, and measured values during active crevice corrosion are extrapolated. These nonphysical results are likely due to nonlinear behavior in high proton and chloride concentrations. Corrosion product precipitation on sensors may also contribute to nonphysical pH values. Although these results limit quantitative analysis, good qualitative agreement is shown between measured sensor potentials and chronoamperometric data shown in FIG. 8B. Thus, the onset of crevice corrosion is easily captured with these sensors. Additionally the use of alternative proton sensitive materials and ion selective polymeric coatings may be substituted for improved quantification.

This XCMT crevice cell was shown to provide 3D tomography profiles of crevice corrosion volume loss to complement electrochemical experiments similar to previous efforts characterizing pitting corrosion (Almuaili et al., J. Electrochem. Soc., 163 (2016) C745; Ghahari et al., Corros. Sci., 53 (2011) 2684-2687; Ghahari et al., Corros. Sci., 100 (2015) 23-35). While electrochemical measurements have significant value, the system described herein highlight the accuracy of XCMT results for tracking crevice corrosion damage. Although the demonstration herein examined accelerated crevice corrosion with larger potentials at short time scale, this approach expected to provide greater utility for longer term potentiostatic evaluation at lower potentials or without potential control. Tomography is also envisioned to be particularly useful for evaluation in the absence of electrochemical monitoring, such as those relying simply upon physical confinement or chemical accelerators typically used in standardized test. The former generally exhibit direct and/or graded contact in the μm scale with the use of plastic or rubber material to mimic more severe crevice scenarios. The latter utilizes chemical oxidizers, such ferric chloride, to accelerate crevice reactions. These testing scenarios are readily adapted to the crevice cell described herein as they omit electrodes required for electrochemical control, thereby simplifying the system.

The chemical monitoring system within the crevice is important in understanding corrosion initiation and propagation with high fidelity. The present approach is particularly relevant for tracking propagation, as potentiometric monitoring can inform XCMT scanning intervals in the absence of chronoamperometry, prior to visible corrosion product, without disrupting the experiment. Slower corrosion rates in the absence of an accelerator should facilitated longer scan times to improve voxel resolution and XCMT scan frequency. However, to this end, significant opportunity for sensor development exists. The reported sensor suffered from drift, low sensitivity and non-Nernstian behavior that hindered quantitative use. Corrosion product precipitation upon the sensor may have also occurred. These challenges may be addressed with polymeric membranes that create physical or ion selective barriers. Additionally the influence of crevice former materials upon corrosion cannot be neglected. Previous work by Guo and coworkers has shown that crevice formers can accelerate crevice corrosion by introducing metal cations that promote crevice conditions (Guo et al., Corros. Sci., 205 (2022) 110462). Indeed the corrosion product chemical feedback effects must be considered in the context of these experiments.

Importantly, coupling this non-destructive system for crevice corrosion analysis with pre-experimental or post-mortem analysis techniques such as scanning electron microscopy or other metallurgical tools can provide additional mechanistic insight. Microanalysis techniques such as EBSD, EDS and SEM allow volume loss to be associated with material phase, orientation and compositional details that can guide our understanding of materials specific pathways for crevice corrosion susceptibility. This is particularly important in the case of additively manufactured materials that exhibit non-equilibrium phases, gradients and voids due to heterogeneous cooling processes. Indeed, recent work has highlighted how distinctly different corrosion properties of additively manufactured alloys are from their wrought and cast counterparts (Sander et al., Corrosion of Additively Manufactured Alloys: A Review, Corrosion, 74 (2018) 1318-1350; Schaller et al., Corrosion Properties of Powder Bed Fusion Additively Manufactured 17-4 PH Stainless Steel, Corrosion, 73 (2017) 796-807; Trelewicz et al., Microstructure and Corrosion Resistance of Laser Additively Manufactured 316L Stainless Steel, JOM, 68 (2016) 850-859).

Demonstrated herein is a cell design for chemical, electrochemical and tomographic characterization of crevice corrosion systems. The cell is constructed from an epoxy embedded sample and a Si crevice former with a Pt thin film potentiometric sensor. The XCMT reconstructions displayed good correlation with coloumbic data in a series of electrochemically accelerated crevice corrosion experiments. Detection of pH within the crevice was qualitatively demonstrated with significant quantitative drift likely due to non-Nernstian behavior from high the combination of high proton and chloride concentration as well as corrosion products. The overall system holds significant utility for better understanding crevice corrosion with multimodal characterization.

An advantage of this cell design over previous technologies is the ability to monitor chemistry, microstructure and electrochemistry in-situ on a single platform. This sort of capability allows continuous or intermittent probing and correlation between measurements in a fashion that allows not only corrosion rates to be determined but tracking of their dynamics on a micron scale. This is particularly challenging in the field of corrosion as corrosion product can obscure this type of analysis. The capability to observe these interactions between microstructure and electrochemical or chemical reactions will also allow development or refinement of crevice corrosion models and greater understanding of crevice corrosion behavior of materials. This capability is expected to hold significant promise especially for additively manufactured structural alloys, or those characterized by small pool melts and anisotropic heating and cooling.

The cell is variable according to the materials, conditions, and corrosion features of interest. For example, the reference electrode may be a Ag/AgCl reference electrode, a saturated calomel electrode, a saturated sulfate electrode, a platinum/hydrogen electrode, or a pseudo reference electrode. The counter electrode may be a platinum wire electrode, a graphite electrode, or a stainless steel electrode. The thin film potentiometric sensor may comprise platinum, a metal oxide, a noble metal, a conducting polymer, a reference electrode system, iridium oxide, gold, silver, antimony, or silver/silver chloride.

The coupons can be prepared in several ways known to corrosion science. This includes different surface finishes and treatments such as primers, inhibitors, thin and thick polymer coatings. The coupons may also have different geometries as long as the cross section is within the range of the XCMT instrument. They may be steel or other material suitable for XCMT measurement by having sufficient electron density contrast. The XCMT system may also be a synchrotron source. The cell is also generally compatible with other spectroscopies such as FTIR, Raman, UV-Vis and NMR. Additional features for temperature monitoring or control and electrolyte exchange can be included using standard techniques known in corrosion science.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. An apparatus comprising:
a housing;
a region within the housing for positioning a sample;
a working electrode within the housing and having a working electrode electrical connection outside the housing;
wherein the working electrode is positioned such that the working electrode is in electrical contact the sample;
a crevice former within the housing and having a crevice former electrical connection outside the housing;
wherein the crevice former comprises a silicon wafer having a thin film potentiometric sensor on a surface of the wafer;
wherein the crevice former is positioned such that the potentiometric sensor is within 100 μm of a surface of the sample;
a counter electrode within the housing and having a counter electrode electrical connection outside the housing; and
a reference electrode within the housing and having a reference electrode electrical connection outside the housing.

2. The apparatus of claim 1, wherein the crevice former comprises a conductive film electrically connecting the potentiometric sensor to the crevice former electrical connection.

3. The apparatus of claim 1, wherein the crevice former comprises a sensor array.

4. The apparatus of claim 1, wherein the reference electrode is a Ag/AgCl reference electrode.

5. The apparatus of claim 1, wherein the reference electrode is a saturated calomel electrode, a saturated sulfate electrode, a platinum/hydrogen electrode, or a pseudo reference electrode.

6. The apparatus of claim 1, wherein the counter electrode is a platinum wire electrode.

7. The apparatus of claim 1, wherein the counter electrode is a graphite electrode or a stainless steel electrode.

8. The apparatus of claim 1, wherein the thin film potentiometric sensor comprises platinum.

9. The apparatus of claim 1, wherein the thin film potentiometric sensor comprises a metal oxide, a noble metal, a conducting polymer, a reference electrode system, iridium oxide, gold, silver, antimony, or silver/silver chloride.

10. A method comprising:
providing the apparatus of claim 1;
placing a sample in the housing;
wherein the sample comprises metal encased in epoxy; and
wherein the surface of the sample comprises the metal;
filling the housing with electrolyte;
performing one or more electrical tests on the sample selected from open circuit potential, polarization, potentiostatic and electrochemical impedance spectroscopy; and
performing X-ray computed microtomography on the sample.

11. The method of claim 10, wherein the sample comprises stainless steel.

12. The method of claim 10, wherein the sample comprises a material suitable for microtomography measurement.
